(19) United States
(12) Patent Application Publication
(10) Pub. No.: US 2024/0171122 A1
(43) Pub. Date: May 23, 2024

(54) BIFACIAL SOLAR PANEL ASSEMBLY WITH A REFLECTOR

(71) Applicant: Gamechange Solar Corp., Norwalk, CT (US)

(72) Inventors: Andrew Barron Worden, Redding, CT (US); Scott Van Pelt, Tarrytown, NY (US); Woo Kim, Little Neck, NY (US)

(73) Assignee: Gamechange Solar Corp., Norwalk, CT (US)

(21) Appl. No.: 18/273,929

(22) PCT Filed: Nov. 23, 2021
(86) PCT No.: PCT/US21/60575

§ 371 Date: Oct. 10, 2023

Related U.S. Application Data
(60) Provisional application No. 63/118,429, filed on Nov. 25, 2020.

(51) Int. Cl. H02S 40/22; H02S 20/32

(52) U.S. Cl. CPC H02S 40/22; H02S 20/32

(57) ABSTRACT

A solar panel installation includes a plurality of bifacial solar panels and a plurality of reflective panels separated from and opposing a back side of the bifacial panels to reflect sunlight onto the back side of the panels. Each of the reflective panels may include a plurality of projections to improve the reflectivity onto the back side of the bifacial solar panels.

### BACKGROUND OF THE INVENTION

### 1. Technical Field

This disclosure relates generally to a solar panel installation and, more particularly, to apparatuses and assemblies for use in a bifacial solar panel installation that includes a plurality of angled surfaces to reflect sunlight onto a bifacial solar panel.

### 2. Background Information

Photovoltaic modules are used to harness energy from the sun. To maximize the energy output of a photovoltaic module, the sun exposure on a sunny day to the photovoltaic module needs to be as direct as possible. Since the position of the sun changes over the course of the day, fixed solar panels cannot operate at peak performance throughout the day.

Systems for increasing directness of sun exposure upon solar panels may use a tracker (e.g., single or dual axis) that improves efficiency of the photovoltaic module. Single axis trackers are structures on which photovoltaic modules are mounted that rotate from east to west so that the photovoltaic modules follow the arch of the sun over the course of the day.

To further increase the output from photovoltaic modules, bifacial solar panels are known. A bifacial solar panel includes a bifacial solar cell that has a front side and back side each configured to capture solar energy. Examples of systems disclosing the use of bifacial solar panels include U.S. Patent Application Publication 2017/0133979 entitled Photovoltaic Apparatus and System Comprising Rotatable Solar Panel and Reflector; U.S. Patent Application Publication 2013/0220402 entitled Bifacial Crystalline Silicon Solar Panel With Reflector; U.S. Patent Application Publication 2020/0119686 entitled Method and Apparatus for Reflecting Solar Energy to Bifacial Photovoltage Modules; and International Patent Application Number WO2010/021678 entitled Solar Collector Panel.

There is a need for improved reflectors to increase the energy output from bifacial solar panels.

### SUMMARY OF THE DISCLOSURE

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to an aspect of the disclosure, an assembly for a solar panel installation comprises a plurality of stationary structural members each having a length that extends longitudinally to a distal member end; a rotatable shaft having a rotatable axis, where the rotatable shaft is rotatably connected to the plurality of stationary structural members at the distal member end; a bifacial photovoltaic panel that includes a front side and an opposing back side; a support connected to the plurality of stationary structural members and parallel with the rotatable axis; and a plurality of solar reflector panels connected to the support and configured to reflect light onto the back side of the bifacial solar panels, where the plurality of solar reflector panels includes a plurality of projections.

The plurality of projections may include first and second sloped sidewalls separated at a projection distal end by a projection top surface.

The projection top surface may be planar.

The first and second sidewalls may be chamfered.

The solar reflector panels may be plastic.

The solar reflector panels may be thermoplastic.

The solar reflector panels may be high density poly ethylene (HDPE).

The solar reflector panels may comprise painted or powder coated steel.

The projections may extend substantially in an east west orientation, perpendicular to the rotatable axis.

The projections may comprise truncated cones.

The projections may comprise truncated trapezoids.

The drive mechanism may comprise a drive arm.

The rotatable shaft may be rotatably connected to the plurality of stationary structural members at the distal member end by one or more bearings.

According to another aspect of the disclosure, an assembly for a solar panel comprises a plurality of stationary structural members each having a length that extends longitudinally to a distal member end; a shaft extending along an axis, where the shaft is connected to the plurality of stationary structural members at the distal member end; a bifacial photovoltaic panel connected by the shaft and including a front side and an opposing back side; a support connected to the plurality of stationary structural members and parallel with the axis; and a plurality of solar reflector panels supported by the support and configured to reflect light onto the back side of the bifacial solar panels, where the plurality of solar reflector panels includes a plurality of projections.

### BRIEF DESCRIPTION OF THE DRAWINGS

FIG. 1 illustrates a solar panel array that includes a plurality of bifacial solar panels;

FIG. 2 illustrates a more detailed view of an embodiment of a solar panel array that includes a plurality of bifacial solar panels;

FIG. 3 is a perspective view of an exemplary embodiment of a reflector panel;

FIG. 4 is a top view of the reflector panel illustrated in FIG. 3; and

FIG. 5 is a side view of the reflector panel illustrated in FIGS. 3-4.

### DETAILED DESCRIPTION

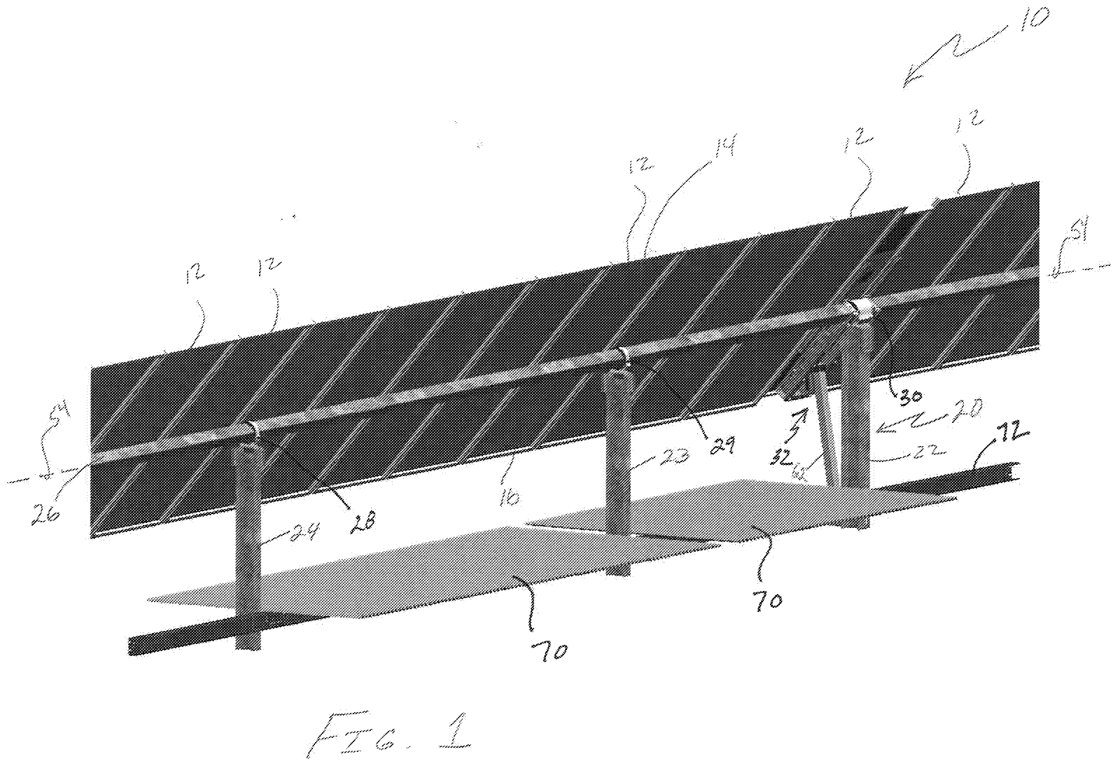

FIG. 1 illustrates a solar panel array 10 that includes a plurality of bifacial solar panels 12. Each bifacial solar panel 12 includes a bifacial solar cell that has a front side 14, and a back side 16, each configured to capture solar energy. The solar panels 12 of the solar panel array 10 are mounted to a racking structure 20. The racking structure 20 includes a plurality of stationary structural members 22-24, a rotatable shaft 26, a plurality of bearing assemblies 28-30, and at least one drive mechanism 32.

The stationary structural members 22-24 may be configured as a center post, or drive mechanism support post. In some embodiments, one or more of the stationary structural members may be securely anchored to the ground. For example, a bottom portion of the member's length may be buried in the ground and/or otherwise secured to or with a foundation, which may be a driven pile, helical screw, screw, precast or cast in place (e.g., Pour-in-Place™ installation system available from GameChange Solar Corp.) or any other foundation type. In other embodiments, one or more of the stationary structural members may be anchored to another structure such as, but not limited to, a building roof top.

An example of a racking structure is disclosed in U.S. Pat. No. 10,605,489 entitled Apparatuses and Assemblies for a Solar Panel Installation, assigned to Gamechange Solar Corp., the assignee of the present application. U.S. Pat. No. 10,605,489 is hereby incorporated by reference.

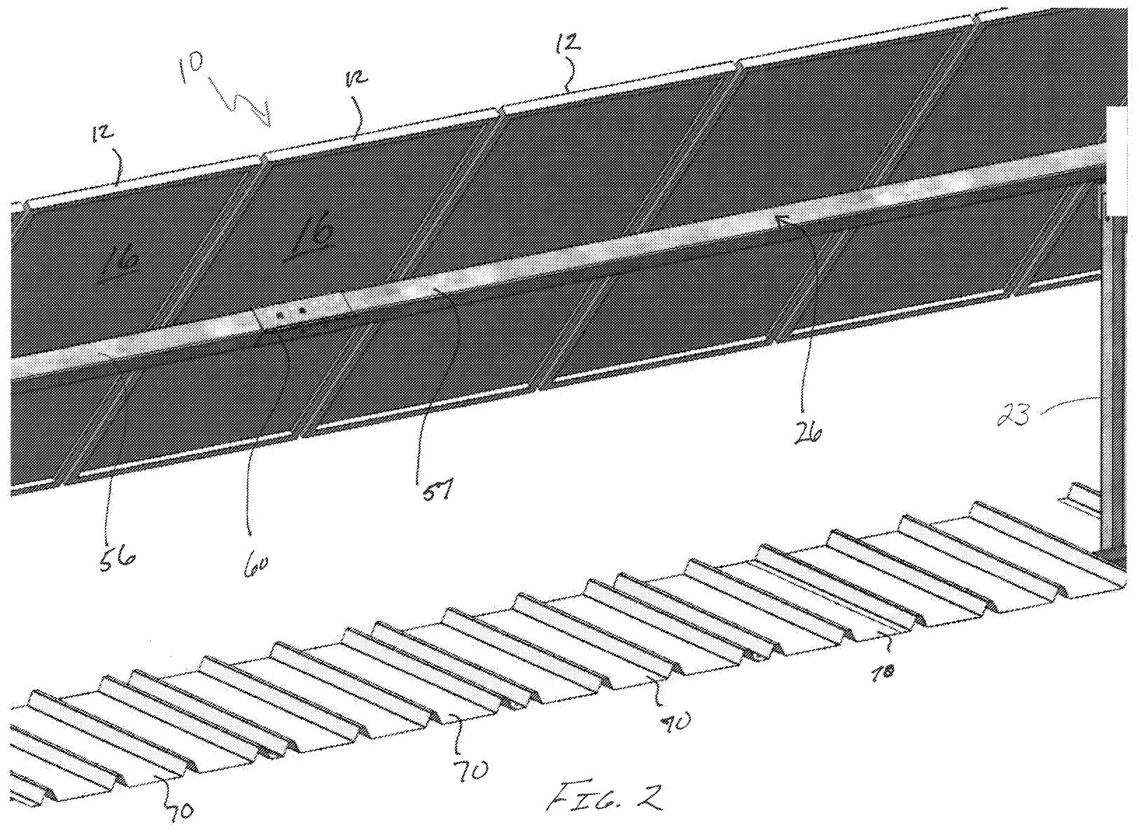

Referring still to FIG. 1, the rotatable shaft 26 has a length, which extends axially (e.g., substantially horizontally when installed) along a rotational axis 54. The rotatable shaft may be configured as a single length of shaft as shown in FIG. 1. Alternatively, the rotatable shaft 26 may be configured with a plurality of shaft segments 56, 57, where adjacent segments are coupled together with a coupler 60 (e.g., a clamping sleeve) as shown in FIG. 2 and/or otherwise connected to one another. The rotatable shaft 26 may include a polygonal (e.g., square) cross-sectional geometry; however, the rotatable shaft of the present disclosure is not limited to such a geometry.

The bearing assemblies 28-30 are configured to rotatably mount the rotatable shaft 26 to the stationary structural members 22-24.

The drive mechanism 32 may include a drive arm 62 to rotate the rotatable shaft 26 about the rotational axis 54 (e.g., as part of a single axis tracker).

Referring now to FIGS. 1 and 2, the solar panel array 10, with the plurality of bifacial solar panels 12, also include one or more reflector panels 70. The reflector panels 70 may be mounted to a planar support 72 (e.g., metallic, non-metallic, wooden, et cetera) attached to each of the stationary structural members 22-24, and to which the reflector panels are mounted. The planar support 72 may be coaxial with respect to the rotatable shaft 26. Depending upon the rigidity of the planar support, it may be attached, for example, to every other stationary structural member. Alternatively, the reflector panels may be supported by a reflector panel support structure that is not attached to the stationary structural members, but is below the solar panels in order to reflect light onto the back sides 16.

The reflector panels 70 are configured to reflect light onto the back side 16 of the bifacial solar panels 12. In one embodiment the reflector panels 70 may be white, reflective, UV resistant plastic (e.g., about 0.05 inches thick). For example, the reflector panels may be a thermoplastic polymer, such as, high density poly ethylene (HDPE). In an alternative embodiment, the reflector panels may be painted/powder coated steel, or other metallic light reflective material, or even any light reflective material (e.g., even mounted deposited or mounted on a substrate).

FIG. 3 is a perspective view of an exemplary embodiment of the reflector panel 70. The panel may include a plurality of projections 74 (e.g., corrugations) extending from a planar reflective surface 76. In one embodiment the projections 74 extend perpendicular to the rotational axis 54. In one embodiment the panel is a unitary (e.g., single piece) structure such that the plurality of projections are also reflective.

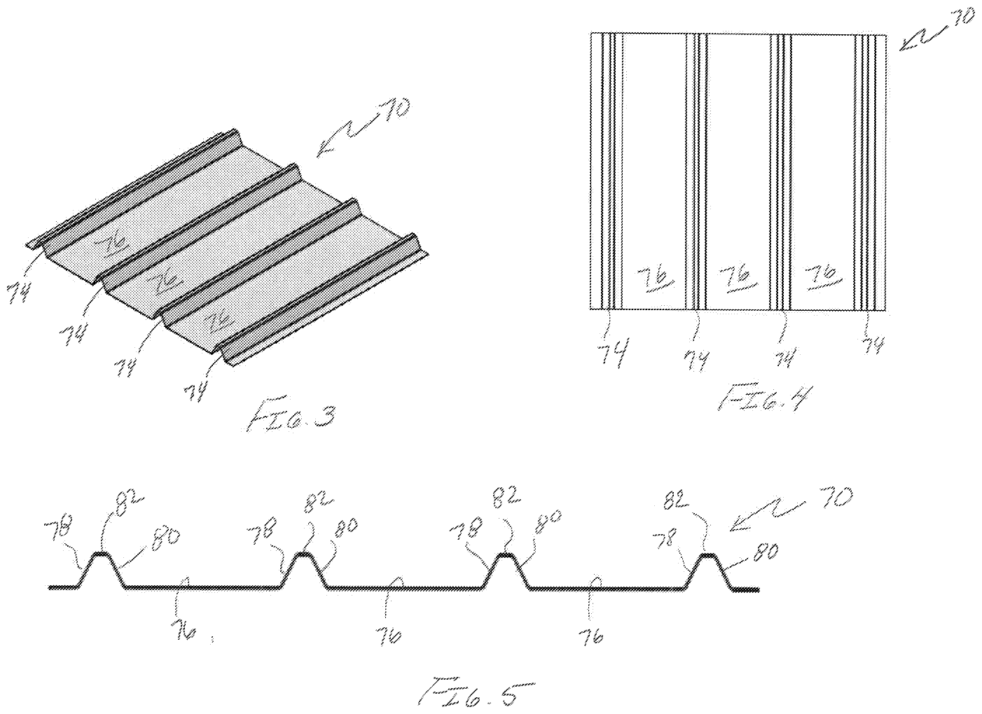

FIG. 4 is a top view of the reflector panel 70 illustrated in FIG. 3.

FIG. 5 is a side view of the reflector panel 70 illustrated in FIGS. 3-4. One or more of the projections 74 may include first and second chamfered sidewalls 78, 80 separated at a distal projection end by a projection top surface 82. In this embodiment the projection top surface 82 may be planar. However, it is contemplated that the projection top surface may be non-planar (e.g., curved). It is also contemplated that the first and second sidewalls 78, 80 may be beveled rather than chamfered. In addition, the sidewall surfaces themselves may include plurality of formed micro projections (e.g., bumps) to enhance the amount of light reflected onto the bifacial panel backside 16. The projections may take on various shapes, including for example, truncated cones, truncated trapezoids, et cetera, or a mixture thereof.

The reflector panels 70 are located off the ground and are supported by the planar support as shown in FIGS. 1-2, which leads to a slight droop of the ends of the reflector panels allowing rain water to remove dirt, dust and debris.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An assembly for a solar panel installation, the assembly comprising:
a plurality of stationary structural members each having a length that extends longitudinally to a distal member end;
a rotatable shaft having a rotatable axis, where the rotatable shaft is rotatably connected to the plurality of stationary structural members at the distal member end;
a bifacial photovoltaic panel that includes a front side and an opposing back side;
a support connected to the plurality of stationary structural members and parallel with the rotatable axis; and
a plurality of solar reflector panels connected to the support and configured to reflect light onto the back side of the bifacial solar panels, where the plurality of solar reflector panels includes a plurality of projections.

2. The assembly of claim 1, where the plurality of projections include first and second sloped sidewalls separated at a distal end by a projection top surface.

3. The assembly of claim 2, where the projection top surface is planar.

4. The assembly of claim 3, where the first and second sidewalls are chamfered.

5. The assembly of claim 2, where the reflector panels are plastic.

6. The assembly of claim 2, where the solar reflector panels are thermoplastic.

7. The assembly of claim 2, where the solar reflector panels are high density poly ethylene (HDPE).

8. The assembly of claim 2, where the solar reflector panels comprise one of painted or powder coated steel.

9. The assembly of claim 2, where the projections extend substantially in an east west orientation, perpendicular to the rotatable axis.

10. The assembly of claim 1, where the projections comprise truncated cones.

11. The assembly of claim 1, where the projections comprise truncated trapezoids.

12. The assembly of claim 1, where the drive mechanism comprises a drive arm.

13. The assembly of claim 1, further a drive mechanism secured to the rotatable shaft connected to rotate the rotatable shaft about the rotational axis.

14. The assembly of claim 13, where the rotatable shaft is rotatably connected to the plurality of stationary structural members at the distal member end by one or more bearings.

15. An assembly for a solar panel installation, the assembly comprising:
a plurality of stationary structural members each having a length that extends longitudinally to a distal member end;
a shaft extending along an axis, where the shaft is connected to the plurality of stationary structural members at the distal member end;
a bifacial photovoltaic panel connected by the shaft and including a front side and an opposing back side;
a support connected to the plurality of stationary structural members and parallel with the axis; and
a plurality of solar reflector panels supported by the support and configured to reflect light onto the back side of the bifacial solar panels, where the plurality of solar reflector panels includes a plurality of projections.

16. The assembly of claim 15, where the plurality of projections include first and second sloped sidewalls separated at a distal end by a projection top surface.

17. The assembly of claim 16, where the projection top surface is planar.

18. The assembly of claim 17, where the first and second sidewalls are chamfered.

19. The assembly of claim 16, where the reflector panels are plastic.

20. The assembly of claim 16, where the solar reflector panels are high density poly ethylene (HDPE).
